(19) United States
(12) Patent Application Publication
(10) Pub. No.: US 2007/0192141 A1
(43) Pub. Date: Aug. 16, 2007

(54) Health care assisting device

(76) Inventors: Tatsurou Kawamura, Kyoto (JP); Eiji Noguchi, Osaka (JP); Yuko Taniike, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/547,310

(22) PCT Filed: Jan. 18, 2006
(86) PCT No.: PCT/JP06/00624

§ 371 Date: Oct. 4, 2006

(30) Foreign Application Priority Data
Feb. 7, 2005 (JP) 2005-031115

(51) Int. Cl. G06F 19/00; G07G 1/00

(52) U.S. Cl. 705/3; 705/10

(57) ABSTRACT

A challenging target value of a lifestyle that is more appropriate for a user is calculated by correcting an influence of an answering tendency of the user.

A target value recording unit (602) of a health care assisting device (600) receives an input of a target value of biological information of the user that is concerned with a challenging item relating to the lifestyle, at the beginning of a predetermined period of time. A measurement value input unit (603) receives an input of a measurement value of the biological information of the user, after the end of the period. An answer sheet input unit (604) receives an input of an answer value which is a self-rated value of the user regarding an achievement level with respect to the target value of the challenging item relating to the lifestyle, after the end of the period. An amendment target value generation unit compares the measurement value of the biological information inputted after the end of the period and the target value of the biological information inputted at the beginning of the period, and corrects the inputted answer value in accordance with the comparison result. A target value update unit (611) decides a next target value of the challenging item relating to the lifestyle that is to be achieved in a subsequent period, on the basis of the post-correction answer value.

### TECHNICAL FIELD

The present invention relates to a health care assisting device that appropriately sets and amends a target value for improving a lifestyle of a user, in accordance with a measurement value of biological information of the user who needs health care and an answer from the user as to how much the user has achieved a target for improving the lifestyle of the user.

### BACKGROUND ART

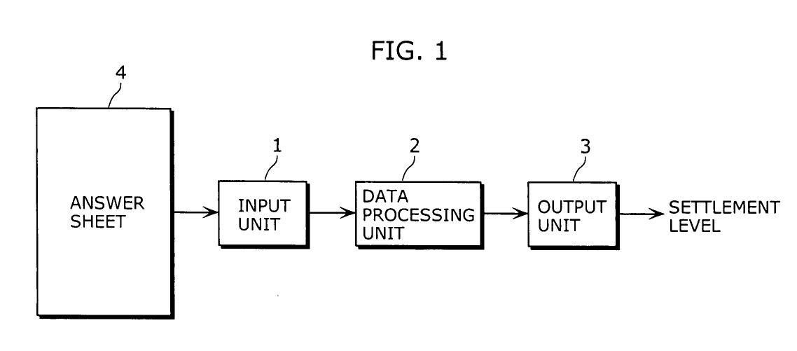

As a conventional health care assisting device, there has been a device, with the aim of improving a lifestyle, that calculates a degree to which the lifestyle improvement is settled into a habit on the basis of answers from the user (see Patent Reference 1, for example). FIG. 1 is a diagram showing a part of the conventional health care assisting device disclosed in the Patent Document 1. The user fills in questionnaire data on an answer sheet 4 and inputs it from an input unit 1 to the health care assisting device. On the basis of the inputted questionnaire data, a data processing unit 2 calculates a settlement level showing how much the lifestyle improvement of the user has settled into a habit. Then, the data processing unit 2 outputs the settlement level to an output unit 3 so as to show it to the user.

Patent Reference 1: Japanese Laid-Open Patent Application No. 2000-37354.

### DISCLOSURE OF THE INVENTION

Problems that Invention is to Solve

However, in the case of the health care assisting device that assists the lifestyle improvement of the user on the basis of the answers from the user, there is a problem that the answers would be affected by an answering tendency which shows a difference between an actual activity of the user and an answer regarding that activity. In fact, as published in Kenko-Eiyo News (Health and Nutrition News) Vol. 3, No. 3 (issued by National Institute of Health and Nutrition in December of 2004, No. 10, p. 7) and in “Himan Ni Tsuite Kangaeru (Study on Obesity)” of Sanseiken Forum (No. 61, February in 2004), a value that should be obtained if a patient who has a medical checkup carries out health care as declared is different from an actual measurement value, in many cases. Moreover, as published in “Tonyobyo Shinryo Master (Japanese Journal of Diabetes Master Clinician)” (by Igaku Shoin Ltd. in March of 2004, Vol. 2, No. 2, p. 230), an activity of the patient and an awareness or an evaluation of the activity may be different from an awareness or an evaluation by a third person regarding an actual activity of the patient.

Especially as to answers to questions about the lifestyle, the patient is likely to make the answers by recalling diets, exercises, and situations when eating tasty things, of the past month. Thus, the answers would be easily affected by a tendency of answering questions about activities of the individual. The reason for this is described as follows.

For a case of a user who needs a lifestyle improvement, an improvement target value for the lifestyle is preset. Then, the user works toward this target value for improving the lifestyle. Here, when this target value is not achievable for the user (the target value is too high), the user will lose a motivation for achievement, thereby failing to improve the lifestyle. On the other hand, when this target value is achievable for the user (the target value is appropriate), the motivation for achievement will be increased. At the same time, the motivation for achievement will be maintained, thereby making the lifestyle improvement work out well. As a result, health maintenance as well as health improvement can be realized. Accordingly, the setting of this target value is important in the lifestyle improvement.

First, this target value is set on the basis of the current health condition and living condition of the user. The living condition is perceived on the basis of the answers from the user. However, in the case where the answers are made in a free description form, it is difficult to perceive the answers because expressions and details may vary from individual to individual. For this reason, the answers are made to items which are categorized as specific as possible, such as diet and exercise. Nonetheless, since it is still difficult even in this case to perceive the answers quantitatively, examples of the living condition are provided so that achievement levels of the user can be given numerically with respect to the examples. This is effective for quantification.

Moreover, in the case where the user makes an answer by giving the achievement level with respect to the target value which was set under an agreement with the user, the user deeply understands the significance of the target value and therefore the motivation for achievement is increased. Also, since fully understanding each item, such as diet and exercise, the user does not make inaccurate answers. This allows the living condition of the user to be more perceivable.

However, generally speaking, the answered value is affected by the answering tendency of the user and is biased due to an individual variation in the answering tendency. As an example, an explanation is given as to the case of a person who shows “well-behaved character” as described in Kodokagaku Kara Mita Kenko To Byoki (Health and Disease from the Viewpoint of Behavioral Science) (published by Medical Friend Co. Ltd., pp. 25-28). The user who shows the well-behaved character is highly motivated to measure up to expectations of a doctor or the like who is in charge of supervising the user. Thus, such a user tends to think of the achievement level of the items supervised by the doctor as being high and gives a high value as an answer. To be more specific, in the same living condition, a user having a stronger well-behaved character is likely to give a higher value as the achievement level with respect to the target value while a user having a weaker well-behaved character is likely to give a lower value as the achievement level. In this way, the answer showing the achievement level varies depending on the answering tendency. This causes a bias in a next target value that is to be set, which ends up with no chance to expect an effect.

As described so far, in the case where the user is asked to answer the achievement level with respect to the target value that represents a challenging target relating to the lifestyle of the user and where the achievement level of the user is to be perceived only from the answer of the user, the answer showing the achievement level is biased due to the variation in the answering tendency of the user. That is to say, the achievement level that is given as the answer may be higher than it really is, and its extent may vary from user to user. As a result, a next target value that is to be set would be an inappropriate value, meaning that an original effect cannot be expected.

The present invention was conceived in view of the stated problem, and an object of the present invention is to provide a health care assisting device which is able to reduce an influence of the answering tendency of the user by correcting the answer regarding the lifestyle using the measurement value of the biological information of the user.

Means to Solve the Problems

A health care assisting device of the present invention is composed of: a measurement value input unit operable to receive an input of a measurement value of biological information of the user; an answer input unit operable to receive an input of an answer value of the user, the answer value being a self-rated achievement level with respect to a challenging target relating to a lifestyle which is concerned with the biological information; and an answer correction unit operable to correct the answer value in accordance with a degree of difference between the answer value and an achievement level with respect to the target of the biological information, the achievement level being calculated from the measurement value of the biological information.

It should be noted here that the present invention is can be realized not only as a discrete health care assisting device described above, but also as: a health care assisting system which is composed of a health care assisting device and an external biological information measurement instrument; and a program which cause a computer to function as some or all of processing units that are included in the stated health care assisting device and the stated health care assisting system. It should be understood that such a program can be widely distributed via a recording medium such as a CD-ROM and a transmission medium such as the Internet.

Effects of the Invention

The health care assisting device of the present invention is able to reduce an influence of the answering tendency of the user exerted over an answer regarding the achievement level of the lifestyle improvement, so that an answer which more correctly reflects the actual lifestyle of the user can be obtained. Thus, the practical value of the present invention is extremely high.

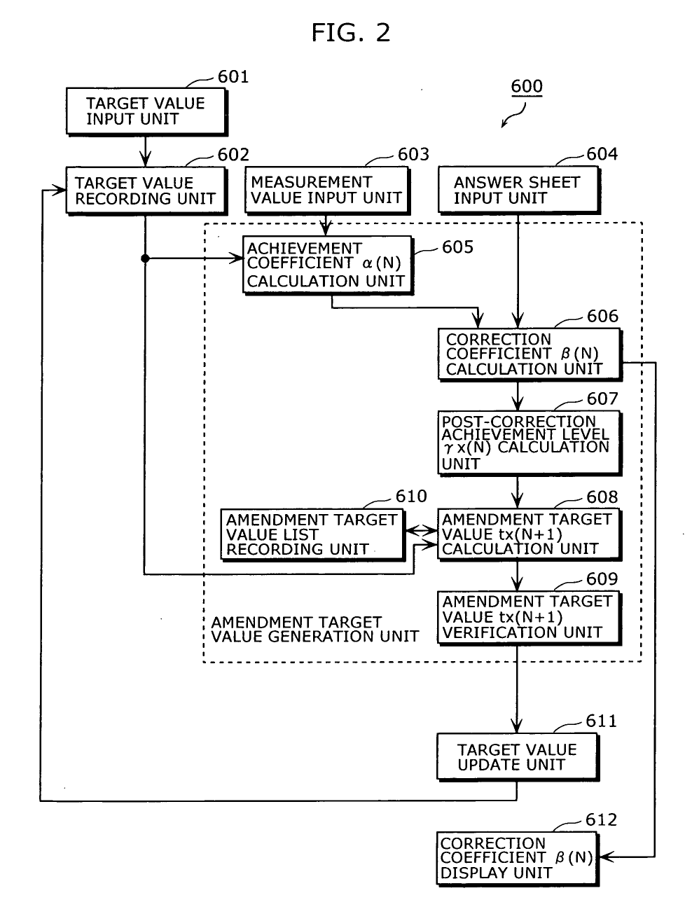

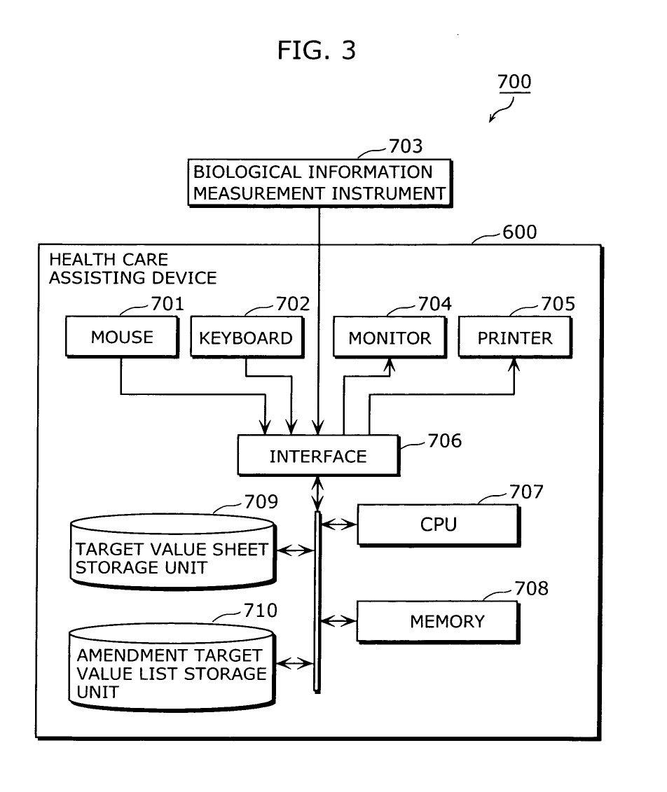

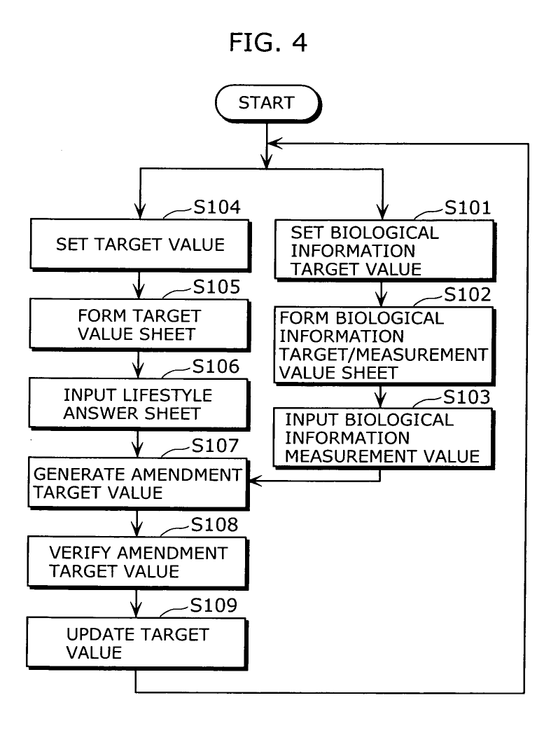

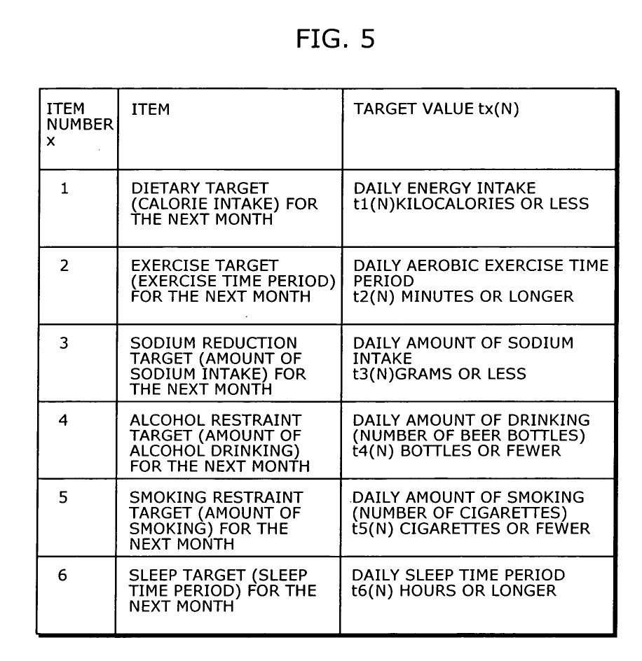

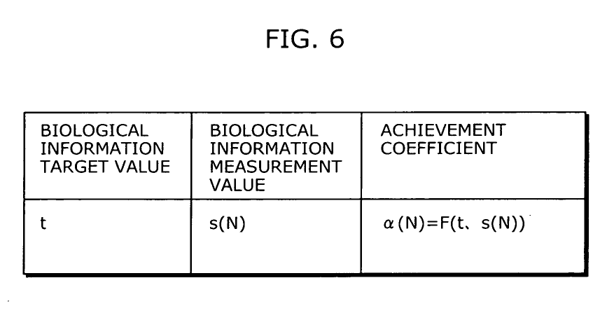

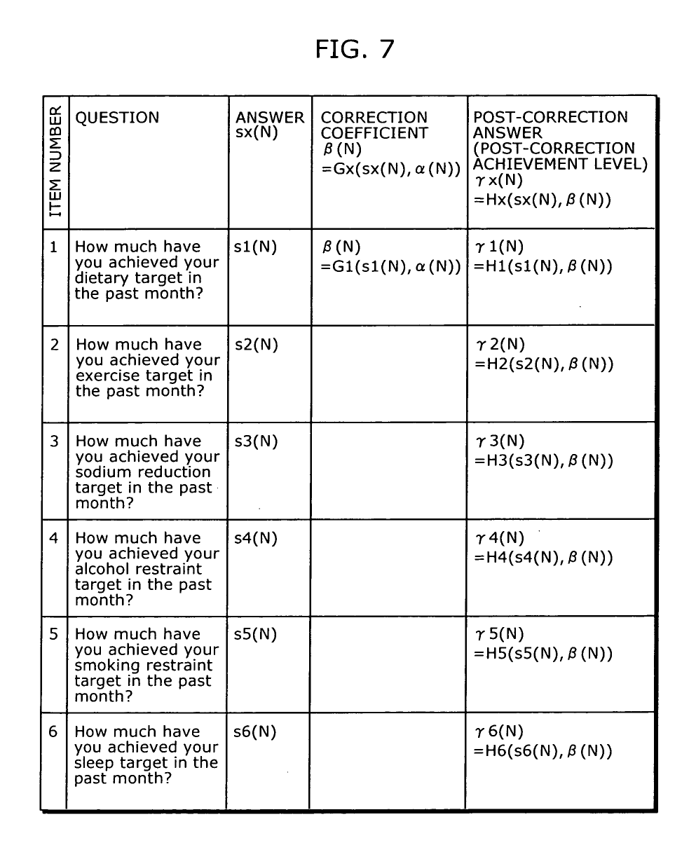

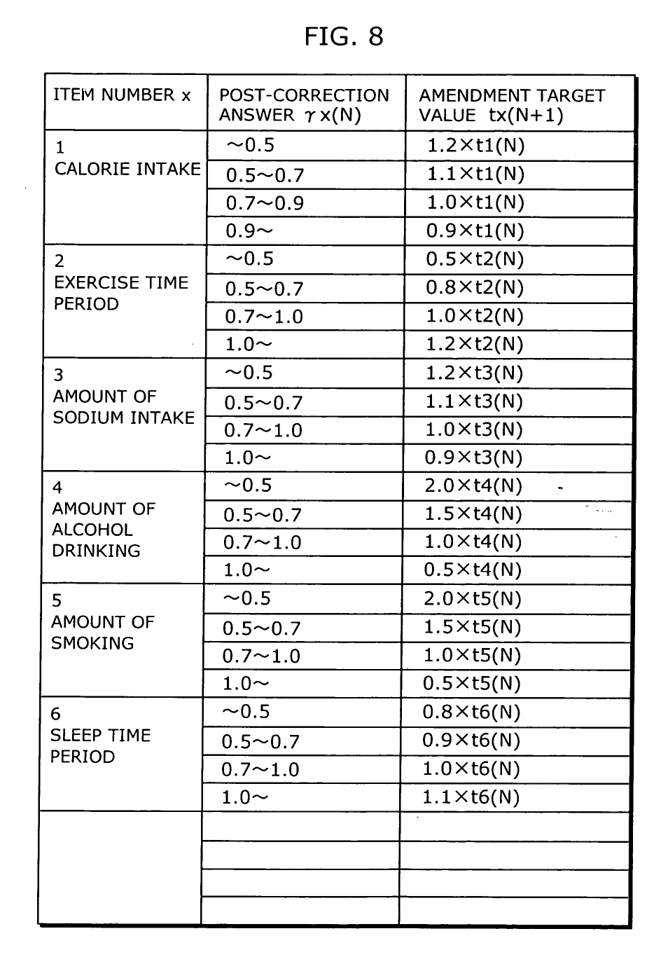

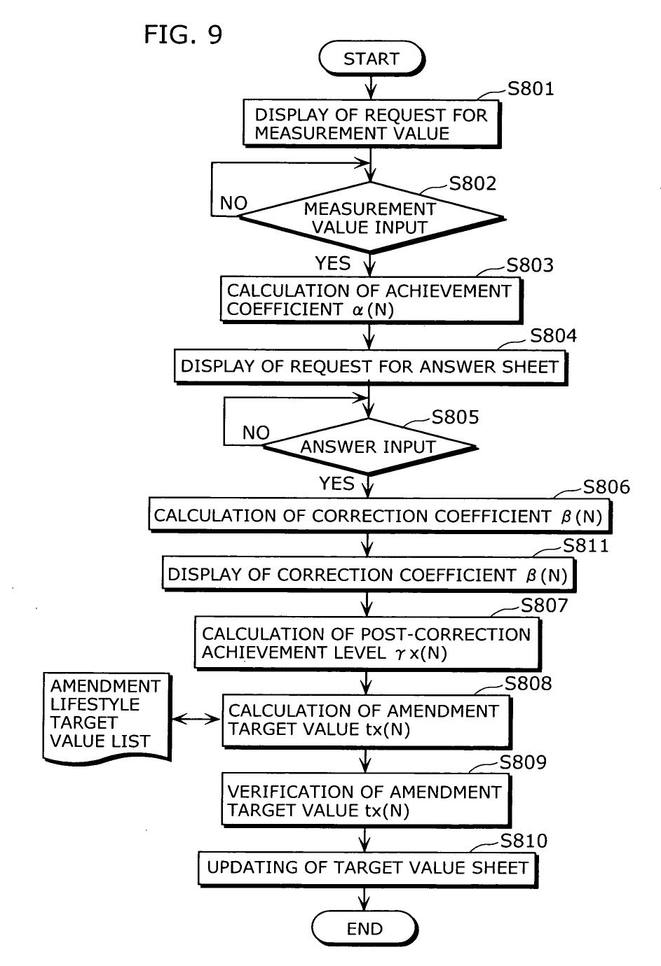

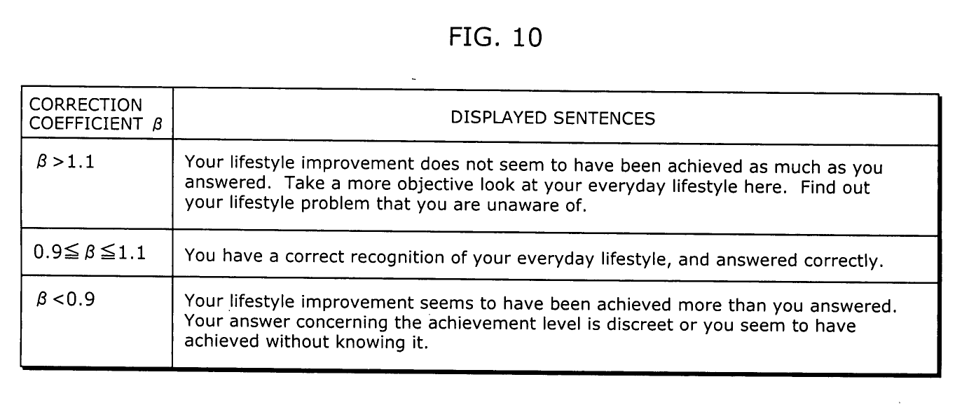

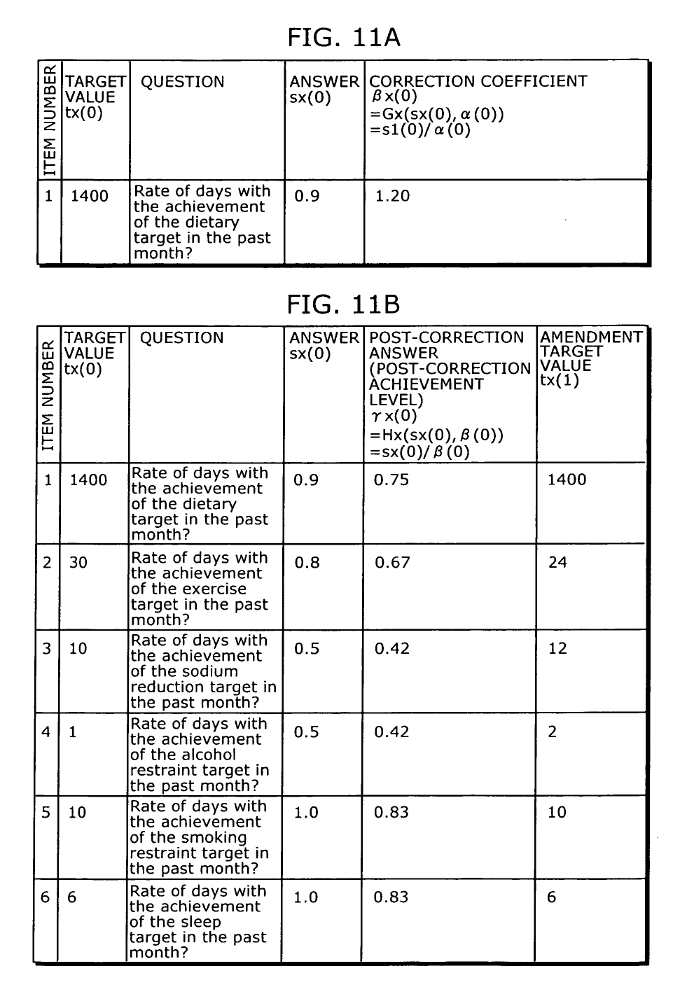

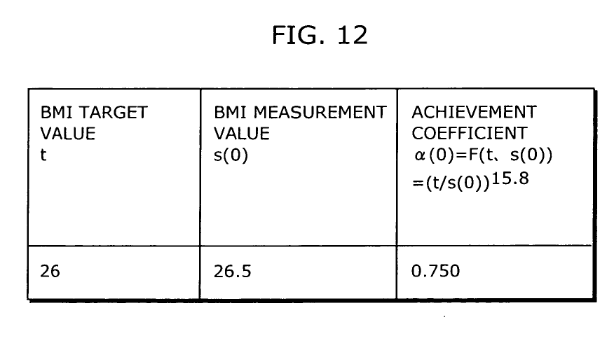

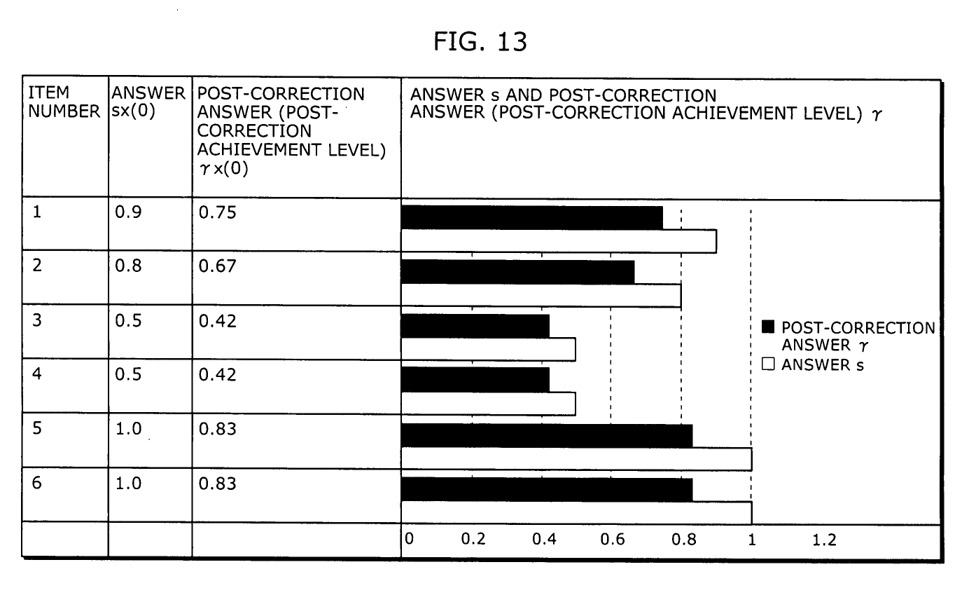

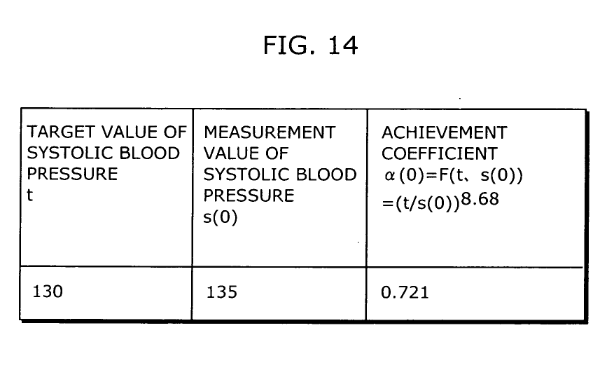

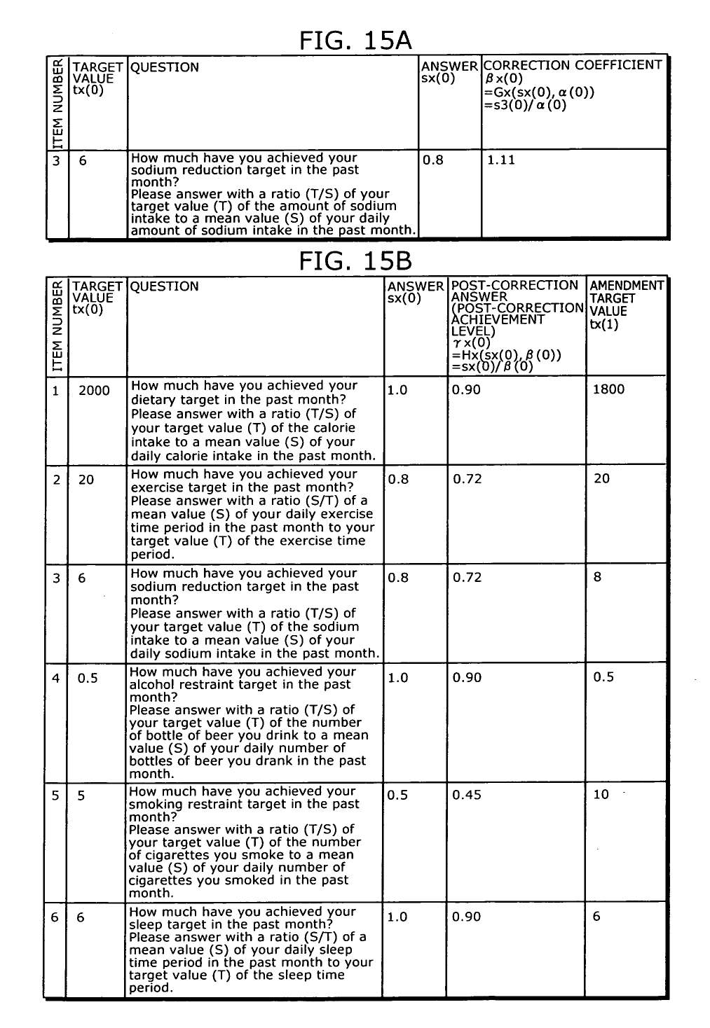

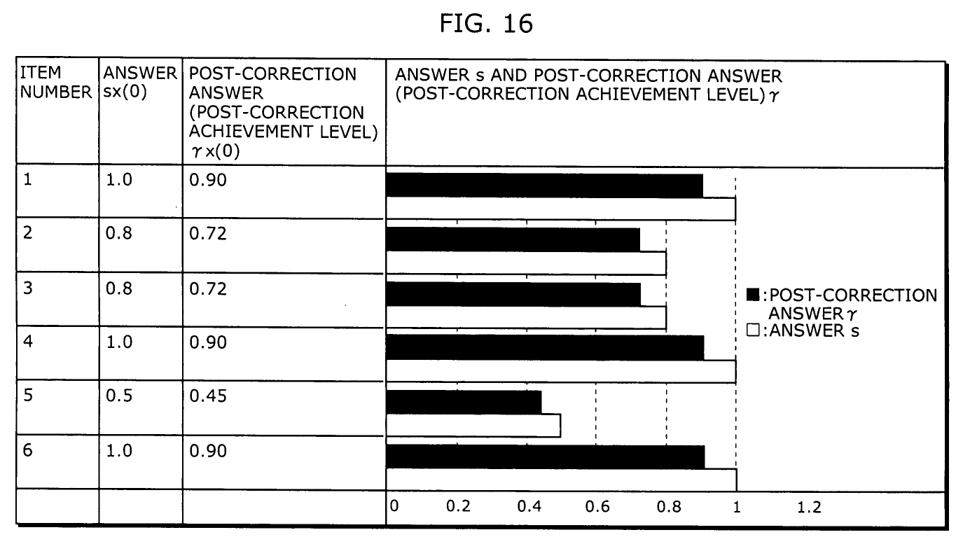

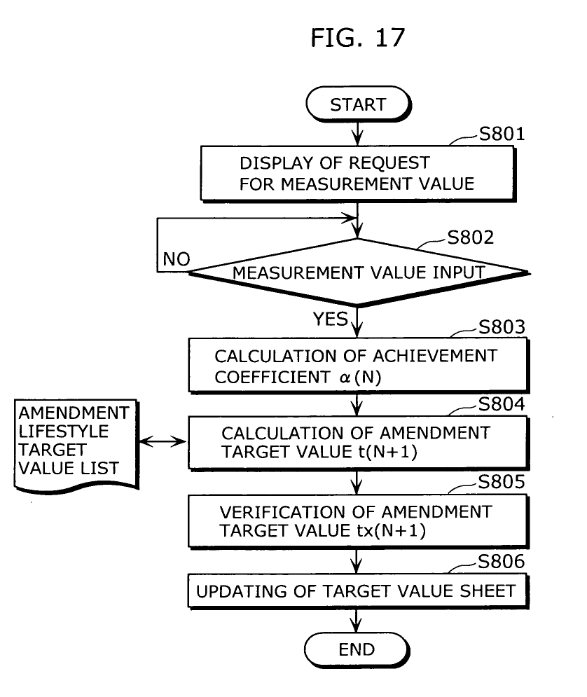

### BRIEF DESCRIPTION OF THE DRAWINGS

[FIG. 1] FIG. 1 is a diagram showing a part of a conventional health care assisting device described in Patent Reference 1.

[FIG. 2] FIG. 2 is a diagram showing a construction of a health care assisting device according to an embodiment of the present invention.

[FIG. 3] FIG. 3 is a block diagram showing a hardware construction of a health care assisting system according the embodiment.

[FIG. 4] FIG. 4 is a flowchart showing a general flow of processing performed by the health care assisting device.

[FIG. 5] FIG. 5 is a diagram showing an example of a lifestyle target value sheet.

[FIG. 6] FIG. 6 is a diagram showing an example of a biological information target/measurement value sheet.

[FIG. 7] FIG. 7 is a diagram showing an example of a lifestyle answer sheet.

[FIG. 8] FIG. 8 is a diagram showing an example of an amendment lifestyle target value list.

[FIG. 9] FIG. 9 is a flowchart showing a more detailed operation performed by the health care assisting device according to the embodiment.

[FIG. 10] FIG. 10 is a table that shows a correspondence between a value of a calculated correction coefficient C and sentences presented to the user on a monitor corresponding to the value.

[FIGS. 11] FIGS. 11A and 11B are diagrams showing examples of the lifestyle target value sheet in the case where the calorie intake is mainly limited.

[FIG. 12] FIG. 12 is a diagram showing an example of the biological information target/measurement value sheet in the case where the biological information is a BMI.

[FIG. 13] FIG. 13 is a diagram showing an example of a case where answers from the user are contrasted on the monitor with post-correction answers obtained through the correction in accordance with the calculated correction coefficient β.

[FIG. 14] FIG. 14 is a diagram showing another example of the biological information target/measurement value sheet according to the embodiment.

[FIGS. 15] FIGS. 15A and 15B are diagrams showing other examples of the lifestyle target value sheet and the lifestyle answer sheet respectively.

[FIG. 16] FIG. 16 is a diagram showing an example of a case where answers from the user are contrasted on the monitor with post-corrected answers obtained through the correction in accordance with the calculated correction coefficient β in the case where the biological information is a systolic blood pressure.

[FIG. 17] FIG. 17 is a flowchart showing a procedure in the case where an amendment target value tx(N+1) is calculated directly from an achievement coefficient α(N) with reference to the lifestyle target value list.

### NUMERAL REFERENCES

600 health care assisting device

601 target value input unit

602 target value recording unit

603 measurement value input unit

604 answer sheet input unit

605 achievement coefficient α(N) calculation unit

606 correction coefficient β(N) calculation unit

607 post-correction achievement level yx(N) calculation unit

608 amendment target value tx(N+1) calculation unit

609 amendment target value tx(N+1) verification unit

610 amendment target value list recording unit

611 target value update unit

### BEST MODE FOR CARRYING OUT THE INVENTION

### FIRST EMBODIMENT

FIG. 2 is a diagram showing a construction of a health care assisting device 600 according to the first embodiment of the present invention.

The health care assisting device 600 in FIG. 2 is a health care assisting device which sets a target value of an item relating to a lifestyle and a target value of biological data, with the aim of improving the lifestyle of the user for a fixed period of time. After a lapse of the fixed period of time, the health care assisting device 600 receives inputs of a measurement value of the biological data and a self-rated achievement level with respect to the target value, and then calculates a next target value which will become a new lifestyle target for a subsequent period of time. The health care assisting device 600 is composed of: a target value input unit 601; a target value recording unit 602; a measurement value input unit 603; an answer sheet input unit 604; an achievement coefficient α(N) calculation unit 605; a correction coefficient β(N) calculation unit 606; a post-correction achievement level yx(N) calculation unit 607; an amendment target value tx(N+1) calculation unit 608; an amendment target value tx(N+1) verification unit 609; an amendment target value list recording unit 610; a target value update unit 611; and a correction coefficient β(N) display unit 612. The amendment target value tx(N+1) calculation unit 608 is an example of an amendment function holding unit that holds an amendment function, used for amending the target value of the lifestyle of a predetermined period of time in accordance with an achievement level achieved during the period of time with respect to the lifestyle target. In the present embodiment, the amendment target value tx(N+1) calculation unit 608 holds an amendment function used for amending the target value corresponding to an item of the lifestyle of the predetermined period of time in accordance with the achievement level achieved during the period of time with respect to the target value corresponding to the item of the lifestyle. The amendment target value tx(N+1) calculation unit 608 and the amendment target value tx(N+1) verification unit 609 are examples of a target value amendment unit that sets the answer value corrected using a correction coefficient β as the achievement level with respect to the lifestyle target and that amends the target value of the period using the amendment function. It should be noted here that x represents a number of an item relating to the lifestyle for which a target value is set, and that N is a positive integer that expresses which period it is, counting from a first time. The target value input unit 601 is an example of a target value input means that, in the case where there are a plurality of challenging targets relating to the lifestyle that the user should achieve during the predetermined period of time, receives inputs of the target values of the plurality of targets and the target value of the biological information that is most concerned with one or more of the plurality of targets. In the present embodiment, the target value input unit 601 is composed of a mouse and a keyboard, by operating which a medical expert or the user inputs the target value. The target value recording unit 602 is an example of a target value recording means that records the target value of the challenging target relating to the predetermined lifestyle. In the present embodiment, the target value inputted from the target value input unit 601 is recorded as explained below. The measurement value input unit 603 is an example of a measurement value input means that receives an input of the measurement value of the biological information of the user. In the present embodiment, the measurement value input unit 603 is an IF (interface) to which the measurement value can be inputted directly from an externally connected biological information measurement instrument, such as a blood pressure meter, a blood sugar meter, or a scale. The answer sheet input unit 604 is an example of an answer input means which receives an input of the answer value that is the self-rated achievement level of the user with respect to the challenging target relating to the lifestyle associated with the biological information. In the present embodiment, the answer sheet input unit 604 is an answer sheet reader which reads an answer sheet the user filled in, or is the mouse or the keyboard that the user operates.

The achievement coefficient α(N) calculation unit 605 is a part of an answer correction means which corrects the answer value in accordance with a degree of difference between the answer value and the achievement level with respect to the target of the biological information, the achievement level being obtained from the measurement value of the biological information. Also, the achievement coefficient α(N) calculation unit 605 is an example of a processing unit which calculates an achievement coefficient a that represents the achievement level with respect to the target of the biological information, on the basis of the measurement value of the biological information and the target value of the biological information. In the present embodiment, the achievement coefficient a(N) calculation unit 605 is a computing unit that calculates an achievement coefficient α(N) according to a predefined arithmetic expression. The correction coefficient β(N) calculation unit 606 is an example of a correction coefficient calculation unit which calculates the correction coefficient β, from the calculated achievement coefficient α, that shows the degree of difference between the answer value and the achievement level with respect to the target of the biological information. In the present embodiment, the correction coefficient β(N) calculation unit 606 is a computing unit that calculates a correction coefficient β(N) according to a predefined arithmetic expression. The post-correction achievement level yx(N) calculation unit 607 is an example of an answer value correction unit which corrects the answer value inputted at the end of the predetermined period of time, using the calculated correction coefficient β(N). In the present embodiment, the post-correction achievement level yx(N) calculation unit 607 is a computing unit that calculates a post-correction achievement level yx(N) from the value of the answer sheet and the correction coefficient β(N) according to a predefined arithmetic expression. The achievement coefficient α(N) corresponds to an achievement level a of the biological information that is calculated from a target value t of the biological information and a measurement value s of the biological information. The correction coefficient β(N) corresponds to a degree of difference between an answer value sx regarding the achievement level with respect to the target of an item x relating to the lifestyle and the achievement level α of the biological information that is obtained from the target value t of the biological information and the measurement value s of the biological information. The post-correction achievement level yx(N) corresponds to a post-correction answer yx. The amendment target value tx(N+1) calculation unit 608 calculates tx(N+1) from an amendment lifestyle target value list described later that is stored in the amendment target value list recording unit 610, on the basis of tx(N). The amendment target value tx(N+1) verification unit 609 imposes a limitation so that the calculated tx(N+1) falls within a range preset for each item x. To be more specific, when tx(N+1) is beyond the preset range, tx(N+1) is fixed to a maximum value of the preset range, whereas when tx(N+1) is below the present range, tx(N+1) is fixed to a minimum value of the preset range. This prevents the target value from becoming so biased as to have a deleterious effect on health in repeated updates of the target value. The target value update unit 611 is an example of a target value decision means that decides a target value by amending the target value of the challenging target relating to the lifestyle, using the post-correction answer value with reference to data showing a correlation between the post-correction answer value and a degree of amendment for the challenging target relating to the lifestyle. In the present embodiment, the target value update unit 611 updates the target value tx(N) recorded in the target value recording unit 602 to the target value tx(N+1).

The correction coefficient β(N) display unit 612 is an example of a display means that display: the degree of difference between the answer value and the achievement level with respect to the target of the biological information, the achievement level being obtained from the measurement value; or the post-correction answer value. In the present embodiment, the correction coefficient β(N) display unit 612 is a display that displays the calculated correction coefficient or what the calculated correction coefficient indicates, that is, a degree of awareness of the achievement level in the lifestyle improvement is displayed to the user. With this display, the user can check the user's own answering tendency. Thus, the user has no choice but to see the lifestyle of the user more objectively and, as a result, the motivation to improve a future lifestyle-related disease can be increased. Those who find it too difficult to improve the lifestyle are reluctant to face the problem in their lifestyle, in other words, many of them shut their eyes to their problems. For such a user, the displaying of the correction coefficient is compelling enough to become aware of the lifestyle problem of the user and, therefore, is especially effective.

The health care assisting device 600 calculates α(N+1), β(N+1), and yx(N+1) on the basis of the target value tx(N+1) updated at the beginning of the (N+1)^{th} period, the measurement value obtained by a measurement which is taken again at the end of the (N+1)^{th} period, and the answer sheet inputted at the end of the (N+1)^{th} period. From these calculated values, the health care assisting device 600 calculates a target value tx(N+2) for a next period of time at the end of the (N+1)^{th} period, and then will repeat this.

FIG. 3 is a block diagram showing a hardware construction of a health care assisting system 700 according the present embodiment. The health care assisting system 700 is a health care assisting system that is composed of the health care assisting device 600 shown in FIG. 2 and an external measurement instrument (a biological information measurement instrument 703). The health care assisting device 600 has a mouse 701, a keyboard 702, a monitor 704, a printer 705, an interface 706, a CPU (Central Processing Unit) 707, a memory 708, a target value sheet storage unit 709, and an amendment target value list storage unit 710. Here, each of the target value sheet storage unit 709 and the amendment target value list storage unit 710 is realized by a hard disk or the like. The user inputs the target values and the answers of the answer sheet using the mouse 701 and the keyboard 702 via the interface 706. The measurement value of the biological information is inputted directly from the biological information measurement instrument 703, such as a blood pressure meter, that is provided outside of the health care assisting device 600, via the interface 706. The target value sheet and the answer sheet are displayed on the monitor 704, and are outputted to the printer 705. The target value sheet and the amendment lifestyle target value list are respectively stored in the target value sheet storage unit 709 and the amendment target value list storage unit 710. There is an interconnection among the interface 706, the target value sheet storage unit 709, the amendment target value list storage unit 710, the CPU 707, and the memory 708 via a bus. The CPU 707 calculates the achievement coefficient α(N), the correction coefficient β(N), and the post-correction achievement level yx(N) on the basis of tx(N) and sx(N) stored in the target value sheet storage unit 709 and the amendment target value list storage unit 710. Then, the target value tx(N) stored in the target value sheet storage unit 709 is updated to tx(N+1).

A general explanation is provided as to a lifestyle improvement assistance for health care performed using the health care assisting device of the present invention, with reference to FIG. 4. FIG. 4 is a flowchart showing a general flow of processing performed by the health care assisting device 600. First, the user preferably consults with a medical doctor or the like, and sets targets (biological information target values) to improve the biological information, such as a blood pressure and an HbA1c, in accordance with an age, previous diseases, and a health condition of the user (S101). At the same time, target values of the lifestyle (target values) such as diet and exercise are set in accordance with the age, the previous diseases, and the health condition of the user (S104). FIG. 5 is a diagram showing an example of a lifestyle target value sheet. FIG. 6 is a diagram showing an example of a biological information target/measurement value sheet. Then, the lifestyle target value sheet and the biological information target/measurement value sheet respectively shown in FIGS. 5 and 5 are formed so that each set value is recorded (S102 and S105). The lifestyle target value sheet and the biological information target/measurement value sheet which are formed here are stored in the target value recording unit 602 at least until the end of the current period of time. In FIG. 5, the target value tx(N) denotes an Nth amended target value for an item x (x is one of 1 to 6) (N=0 when the target value is set for the first time). In FIG. 6, each N of a biological information measurement value s(N) and an achievement coefficient α(N) which are recorded in the biological information target/measurement value sheet denotes the same meaning (i.e., the N^{th} amended target value). However, in this step, the biological information measurement value s(N) and the achievement coefficient α(N) have yet to be inputted.

Next, the user tries to improve the lifestyle with reference to the formed lifestyle target value sheet. In the case where the period of time is one month, for example, the user measures the biological information, such as the weight, the blood pressure, the blood cholesterol, and the HbA1c, after a lapse of one month (5103) and inputs the measurement values to the biological information target/measurement value sheet (FIG. 6). At the same time, the user inputs levels showing how much the user has achieved with respect to the lifestyle target values, into a lifestyle answer sheet by remembering the lifestyle of the past month (S106). FIG. 7 is a diagram showing an example of the lifestyle answer sheet. In FIG. 7, an answer sx(N) is an index that shows the achievement level inputted for the N^{th} time with respect to the item x (x is one of 1 to 6). For example, in the case of an item 1 relating to the diet (target value=total daily energy intake: tl(N) kcal or less), the user inputs a rate of days in the past month on which the user could achieve the daily energy intake of tl(N) kcal or less. To be more specific, the user inputs 1.0 when having achieved on all of the days, 0.5 when having achieved on only half of the days, and 0.0 when not having achieved on any day.

Then, the health care assisting device 600 calculates the achievement coefficient α(N) that shows the achievement level of the biological information, using a function α(N)=F(t, s(N)) from the biological information measurement value s(N) and the target value t of the biological information. Moreover, the health care assisting device 600 calculates the correction coefficient β(N) for correcting the achievement level inputted into the lifestyle answer sheet, using the correction coefficient β(N)=Gx(sx(N), α(N)) from the achievement level sx(N) and the achievement coefficient α(N) relating to the item of the lifestyle associated with the present biological information measurement value s(N) out of the achievement level answers inputted into the lifestyle answer sheet. Furthermore, the health care assisting device 600 calculates the post-correction achievement level yx(N) using the post-correction answer yx(N)=Hx(sx(N), β(N)), from the correction coefficient β(N) and the achievement level sx(N) inputted into the lifestyle answer sheet. Next, an amendment target value is generated by calculating an amendment target value tx(N+1) on the basis of the amendment lifestyle target value list from the post-correction achievement level yx(N) (S107). FIG. 8 is a diagram showing an example of the amendment lifestyle target value list. As shown in this diagram, the amendment lifestyle target value list shows a mathematical expression for each item relating to the lifestyle for calculating the amendment target value tx(N+1) for a next period by multiplying the target value tx(N) of the present period by a coefficient corresponding to the post-correction answer yx(N).

Moreover, the health care assisting device 600 verifies whether or not this amendment target value tx(N+1) has no problem from a medical point of view (S108). For example, amendment target values of diet, exercise, and sodium reduction are limited within respective predetermined ranges. As an example, since a minimum amount of sodium intake per day is 0.5 g in general. Thus, when the amount of sodium intake per day that is calculated from the amendment lifestyle target value list is 0.5 g or less, the range is set to 0.5 g.

Next, the health care assisting device 600 forms the lifestyle target value sheet in which the target value tx(N) that was set and recorded at the beginning of the period is updated to a new target value tx(N+1) (S109). The user again tries to improve the lifestyle with reference to the updated lifestyle target value sheet. By this repetition, the lifestyle of the user will be improved.

In this way, sx(N) which is a self-rated value depending on a memory of the user after a lapse of, for example, one month since the lifestyle improvement started is corrected using the achievement coefficient α(N) derived from s(N) which is an objective measurement value. By doing so, a difference in character of the user, such as a difference in the tendency when answering the achievement level, can be corrected. Thus, the lifestyle target values can be set, appropriate to the health condition and the actual condition of the lifestyle of the user.

A specific explanation is given as to operations performed by the health care assisting device 600 constructed as described so far, with reference to FIGS. 9, 10, 12, and 11. An example of the health care assistance in the case where the user is a diabetic is cited with reference to FIGS. 12 and 9. FIG. 9 is a flowchart showing a more detailed operation performed by the health care assisting device 600 according to the present embodiment. FIG. 10 is a table that shows a correspondence between a value of a calculated correction coefficient βand sentences presented to the user on the monitor corresponding to the value. FIGS. 11A and 11B are diagrams showing examples of the lifestyle target value sheet in the case where the calorie intake is mainly limited. FIG. 12 is a diagram showing an example of the biological information target/measurement value sheet in the case where the biological information is a BMI (Body Mass Index). Here, the BMI that is calculated from the height and the weight (weight (kg))/(height (m))2) is used as the biological information. First, the height and the weight of the user are measured. When the height is 1.65 m and the weight is 73 kg, i.e., BMI=26.8, it is desirable for the user to lower the BMI. For this reason, a target value of the BMI to be achieved in one month is set to 26 in consideration of the health condition of the user as shown in FIG. 12. Moreover, the target value tx(0) (x is an integer 1 to 6) for a next month is set for each of six items relating to the lifestyle in consideration of the target value of the BMI as well as the health condition and the lifestyle conditions of the user, as shown in FIG. 11. Here, in the case of an adult, the height will not change in one month or so, and therefore it may be only necessary to measure the weight. Also, since the weight depends most strongly on the diet, which is the item 1 in FIG. 11, the weight as the biological information and the item 1 are associated with each other. On account of this, the diet energy is set to a target value that would cause the BMI to be 26 in one month. More specifically, the target value that would cause the BMI to be 26 when a full achievement is accomplished (the achievement level=1.0) is set. In the present embodiment, the target value is set to 1400 kcal. It should be noted here that this target value is decided on the basis of the biological information of the user, such as the age, the weight, the height, and the basal metabolism, and the amount of exercise, with reference to an example of the weight reduction success published in “Nyobyo Ryoyo Shido Niko No Hiketsu (Diabetes Treatment Guidelines—Know-How in Double Spread)” (published by Kanehara & Co., LTD), pp. 204-205, for example.

The user tries to improve the lifestyle, with reference to the lifestyle target value sheet shown in FIG. 11B. At this point in time, only the item numbers and the target values are filled in the lifestyle target value sheet. One month later, the user activates the health care assisting device 600 and measures the weight again. The CPU 707 of the health care assisting device 600 requests the biological information measurement instrument 703 to input the measurement value of the biological information (S801). The biological information measurement instrument 703 then inputs the measurement value (S802). In the present case here, BMI=26.5. Next, the achievement coefficient a(N), i.e., the achievement coefficient α(0), is calculated (S803). Here, a case of (a mathematical expression 5) α(0)=F(t, s(0))=(t/s(0))k where k=15.08 is shown. To be more specific, α(0)=F(t, s(0))=(t/s(0))15.08=(26/26.5)15.08. As a result, α(0)=0.750.

Next, the health care assisting device 600 requests for an input of the answer sheet (S804). The user recalls the lifestyle of the past month and inputs sx(0) (x is an integer 1 to 6). In the present embodiment, in the case where the user thinks that the number of days in the past month on which the diet target was achieved is 27 days, for example, the user inputs s1(0)=0.9. Moreover, in the case where the user thinks that the number of days in the past month on which the exercise target was achieved is 24 days, the user inputs s2(0)=0.8. Similarly, the user gives other values of sx(0), answering the questions shown in FIG. 11. The health care assisting device 600 checks whether or not all of the items are filled in the answer sheet (S805), and calculates the correction coefficient β(0) (S806). Here, since the biological information BMI and the item relating to the diet are associated with each other, the correction coefficient β(0) is calculated from α(0) and s1(0). Also, the calculation is performed for a case of (a mathematical expression 6) the correction coefficient β(0)=G(α, sx)=(sx/α)l where l=1 here. To be more specific, Gx(sx(0), α(0))=s1(0)/α(0). As shown in FIG. 11A, the correction coefficient β(0)=1.20, corresponding to the inputted s1(0)=0.9. Then, the calculated correction coefficient β(0) is displayed on the display for the user (S811). However, when a numerical value of the correction coefficient β is displayed as it is, there may be a possibility that the user will not understand what the numerical value indicates. For this reason, a degree of the user's awareness of the achievement level in the lifestyle improvement is displayed in the sentences, for example, in accordance with the calculated value of the correction coefficient β, as shown in FIG. 10. As described above, the correction coefficient β(0) was calculated as β(0)=1.20 in step S806. In a case like this where the value of the correction coefficient β exceeds “1.1”, the correction coefficient β(N) display unit 612 displays that the user has not become precisely aware of the achievement level of the lifestyle improvement, in plain language that the user understands.

Next, the post-correction achievement level yx(0) is calculated using sx(0) and β(0) (S807). Here, the calculation is performed for a case of (a mathematical expression 7) Hx(sx, β)=(sx/β) and yx(0)=Hx(sx(0), β(0))=sx(0)/β(0). For example, the post-correction achievement level of the calorie intake is: y1(0)=s1(0)/β(0)=0.9/1.20=0.75.

Moreover, tx(N+1) is calculated by checking the calculated yx(N) against the amendment lifestyle target value list (S808). To be more specific, the amendment target value tx(1) is calculated from yx(0), with reference to the amendment lifestyle target value list. Here, since y1(0)=0.75, the amendment target value t1(1)=1.0*t1(0).

Next, tx(N+1) is verified (S809). To be more specific, the amendment target value tx(1) calculated in this way is verified by the amendment target value tx(N+1) verification unit 609. As a result of the verification, the amendment target value tx(1) calculated from yx(0) and the amendment lifestyle target value list of FIG. 8 could be used as the target value for the next month in the present embodiment. Consequently, the target value of the lifestyle for the next month can be decided and all of the items in FIG. 11B are filled in (S810). Then, the user can try to improve the lifestyle for another month toward this updated target value.

As described above, a difference between the target value and the measurement value of the biological information is indexed as the achievement coefficient α(0) in the (mathematical expression 5). In the case of the present embodiment, the achievement coefficient α(0)=0.750, which is an objective numerical value based on the measurement value of the biological information. On the other hand, s1(0)=0.9 which is an answer for the item of the lifestyle associated with this biological information is a subjective numerical value that is answered as the achievement level recognized by the user. A deviation between the objective numerical value and the subjective numerical value is indexed as the correction coefficient β(0) in the (mathematical expression 6). Using this correction coefficient β(0), the subjective numerical values of S2(0), S3(0) . . . S6(0) can be corrected and changed into objective numerical values. In the present example, the user subjectively believes to have achieved for 27 days, that is, 0.9, but could achieve only 0.75 in reality. This shows that the user has a tendency to evaluate the user's own achievement level higher. It follows that the user has a tendency to evaluate the other items relating to the lifestyle higher as well. For this reason, the post-correction achievement level yx(0) is calculated by correcting this tendency using the correction coefficient β(0), so that the bias of the answering tendency of the user is compensated. Then, a next target value is set on the basis of the post-correction achievement level yx(0) that is obtained by compensating the bias of the answering tendency. Accordingly, the achievement level of the user can be perceived without an influence from the character and the like of the user, and an appropriate target value which is achievable for the user can be set. Owing to this, the motivation of the user for achievement can be expected to increase.

It should be noted here that the index coefficients, such as k and l, are adjusted in accordance with a characteristic of the biological information and a characteristic of the lifestyle.

As described so far, the health care assisting device 600 according to the present embodiment can set a target value of the lifestyle that is appropriate for the user by compensating a tendency of the user in recognizing the user's own achievement level, and is effective at improving the lifestyle of the user.

The present embodiment has described an example where the correction coefficient β is definitely displayed regardless of a value of the correction coefficient beta. However, the correction coefficient β may be displayed only when it deviates a predetermined value or more from 1. This allows the user to know the fact that the correction was needed only when a substantial correction was needed. Or, it is also effective in the case where the correction coefficient is not necessarily displayed but only the fact that the correction was needed is displayed. Moreover, in the case where the correction coefficient or/and the fact that the correction was needed is/are displayed on a screen of the monitor that appears after the completion of the input to the answer sheet by the user, this easily impresses the user and is especially effective. Furthermore, although the above embodiment described an example where the correction coefficient β is displayed in step S811 of FIG. 9 in order for the user to become correctly aware of the achievement level that shows how much the target of the lifestyle improvement has been achieved, the present invention is not limited to this. FIG. 13 is a diagram showing an example of a case where answers from the user are contrasted on the monitor with post-correction answers obtained through the correction in accordance with the calculated correction coefficient β. This diagram presents a degree of precision with which the user recognizes the achievement level with respect to the target for the lifestyle improvement, not by the sentences, but by contrasting, for example, the numerical answer value from the user with the post-correction numerical answer value. Additionally, this diagram shows at a glance a difference between the answer from the user and the post-correction value using a bar graph, not simply by comparing the numerical values. Owing to this, the user can become aware of the fact that there is a difference between the achievement level the user believed to have achieved and the actual achievement level. Moreover, this diagram allows the user to know a degree of the difference between the achievement level the user believed and the actual achievement level.

### ANOTHER EXAMPLE

The following is an explanation of another example using the present embodiment, with reference to FIGS. 14, 15, and 16. Note that, in this example, the explanation is presented as to a case of a health care assistance given to the user who has a high blood pressure, and that the biological information to be measured is mainly a systolic blood pressure. FIG. 14 is a diagram showing another example of the biological information target/measurement value sheet according to the present embodiment. FIG. 15 is a diagram showing other examples of the lifestyle target value sheet and the lifestyle answer sheet. FIG. 16 is a diagram showing an example of a case where answers from the user are contrasted on the monitor with post-corrected answers obtained through the correction in accordance with the calculated correction coefficient β in the case where the biological information is a systolic blood pressure.

The user first measures the systolic blood pressure. The measured systolic blood pressure is 140 mmHg, and it is desirable for the user to lower the blood pressure. For this reason, the user consults with a medical doctor or the like and then sets a target value t of the systolic blood pressure to be achieved in one month to 130 mmHg which is achievable for the user in consideration of the health condition of the user, as shown in FIG. 14. Moreover, as shown in FIG. 15, the target value tx(0) (x is an integer 1 to 6) for a next month is set for each of six items relating to the lifestyle in consideration of the target value of the blood pressure as well as the health condition and the lifestyle condition of the user. Here, the blood pressure depends most strongly on the amount of sodium intake shown in the item 3 of FIG. 15. Thus, the blood pressure as the biological information and the item 3 are associated with each other. On account of this, a sodium-reduction target value is set to a target value that would cause the systolic blood pressure to be 130 mmHg in one month. To be more specific, the target value that would cause the systolic blood pressure to be 130 mmHg when a full achievement is accomplished (the achievement level=1.0) is set. In the present embodiment, the target value is set to 6 g. It should be noted here that this target value is decided on the basis of salt sensitivity of the blood pressure of the user, as published in Koketsuatsu Navigator (High Blood Pressure Navigator) (by Medical Review Co., Ltd, pp. 16-17 and pp. 116-117), for example.

As is the case with the above-mentioned example, the user tries to improve the lifestyle with reference to FIG. 15. When the user measured the blood pressure again one month later, the value was 135 mmHg. Next, the achievement coefficient α(0) is calculated. The present embodiment shows a case of (a mathematical expression 5) α(0)=F(t, s(0))=(t/s(0))k where k=8.68. In this case, F(t, s(0))=(t/s(0))8.68. As a result, α(0)=0.721. Then, the user recalls the lifestyle of the past month and inputs sx(0) (x is an integer 1 to 6). In the present example, the user remembered a mean value of the dietary calorie intake per day regarding the item 1 of the past month, as the mean value (S)=2000 kcal. Therefore, the user made an answer for s1(0) regarding a ratio of the target value of the calorie intake (T)=2000 kcal to the mean value S of the calorie intake as (T/S)=1.0. Moreover, the user thought that a mean value of exercise time period per day of the past month, as the mean value (S)=16 minutes. Thus, the user made an answer for s2(0) regarding a ratio of S to the target value of exercise time period (T)=20 minutes, as (S/T)=0.8. Similarly, the user gives other values of sx(0), answering the questions shown in FIG. 15.

Then, the correction coefficient β(N) calculation unit 606 calculates the correction coefficient β(0). Here, since the blood pressure as the biological information and the amount of sodium intake are associated with each other, the correction coefficient β(0) is calculated from β(0) and s3(0). The present example shows a case of (a mathematical expression 6) G(α, sx)=(sx/α)l where l=1. Also, the correction coefficient β(0)=Gx(sx(0), α(0))=s3(0)/α(0). As a result, the correction coefficient β(0)=1.11.

Next, the health care assisting device calculates the post-correction achievement level yx(0) using sx(0) and β(0). The present embodiment shows a case of (a mathematical expression 7) Hx(sx, β)=(sx/β) and yx(0)=Hx(sx(0), β(0))=sx(0)/β(0). In this case, y3(0) is calculated according to y3(0)=s3(0)/β(0). The amendment target value tx(1) is calculated from the calculated y3(0)=0.72 and the amendment lifestyle target value list shown in FIG. 8. Here, the amendment target value tx(1) is verified. In this way, the target values of the lifestyle for a next month are decided and all of the items in FIG. 15 are filled in. Then, the user can try to improve the lifestyle again toward these updated target values.

In the case of the present embodiment, α(0)=0.721, which is an objective numerical value based on the measurement value. On the other hand, s3(0)=0.8 which is an answer for the item of the lifestyle associated with this biological information is a subjective numerical value that is answered as the achievement level recognized by the user. A deviation between this objective numerical value and this subjective numerical value is indexed as the correction coefficient β(0) in the (mathematical expression 6). Using this correction coefficient β(0), the subjective numerical values of s2(0), s3(0) . . . s6(0) are corrected and changed into objective numerical values. In the present embodiment, the user believes to have achieved 0.8, but could achieve only 0.721 in reality. Although not as much as the above-mentioned user, this user also has a tendency to evaluate the user's own achievement level higher. It follows that the user has a tendency to evaluate the other items relating to the lifestyle higher as well. For this reason, the post-correction achievement level yx(0) is calculated by correcting the answers of the user having this tendency using the correction coefficient β(0), so that the bias of the answering tendency of the user is compensated. Then, a next target value is set on the basis of the post-correction achievement level yx(0) that is obtained by compensating the bias of the answering tendency. Accordingly, the target value achievable for the user can be set, thereby increasing the motivation for achievement. In addition to this, the displaying of the answer from the user in contrast with the post-correction answer as shown in FIG. 16 allows the user to see the bias of the answering tendency, which in turn allows the user to answer more objectively for the other items relating to the lifestyle.

As described so far, it is effective that a target value of the lifestyle which is appropriate for the user can be set by compensating a tendency of the user in recognizing the user's own achievement level.

In the above embodiment, the explanation was presented as to the case where the BMI and the blood pressure are used as the biological information. However, an HbA1c (an index showing a mean value of the blood glucose level of the past one to two months) may be used as the biological information and the amount of sugar intake may be used as an item relating to the lifestyle. Alternatively, a total cholesterol concentration in the blood may be used as the biological information and the amount of fat intake may be used as an item relating to the lifestyle.

It should be noted that for the case where the above embodiment is implemented in a simpler way, an achievement coefficient α(N) may be calculated from, for example, a biological information target value t(N) and a biological information measurement value s(N) which are most concerned with the item relating to the lifestyle, then an amendment target value tx(N+1) may be calculated directly from the calculated achievement coefficient α(N) with reference to the lifestyle target value list. FIG. 17 is a flowchart showing a procedure in the case where the amendment target value tx(N+1) is calculated directly from the achievement coefficient α(N) with reference to the lifestyle target value list. As shown, in the case where the amendment target value tx(N+1) is calculated directly from the calculated achievement coefficient α(N) with reference to the lifestyle target value list, it is considered that a degree of appropriateness of the amendment target value tx(N+1) for the user decreases. However, as is obvious from a comparison between FIG. 9 and FIG. 17, there is an effect that a throughput of the health care assisting device can be greatly reduced.

In the above embodiment, the achievement level shown by the answer value is corrected on the basis of the achievement coefficient α(N). However, the present invention is not limited to this, and a next target value of a measurement value of the biological information may be corrected using the achievement coefficient α(N). Then, a target value of an item relating to the lifestyle may be decided so as to cause the measurement value to be this corrected target value at the end of a next period for the lifestyle improvement.

### INDUSTRIAL APPLICABILITY

The health care assisting device of the present invention can be applied to a health care assisting device that amends a target value of the lifestyle by correcting an answer regarding the lifestyle of the user in accordance with a measurement value of the biological information of the user who needs health care. To be more specific, the health care assisting device of the present invention is useful as a home personal computer, a PDA, a car navigation device, or a cellular phone that allows communication with a medical doctor in a hospital or the like via a communication network or the like.

The measurement instrument of the present invention is useful as: a measurement instrument, such as a home toilet device, a blood pressure meter, or a scale, that is connected to a hospital or the like via a communication network; household equipment such as a bed; and sanitary equipment such as a toilet device provided in public facilities and the like.

1. A health care assisting device for assisting health care of a user, comprising:
a measurement value input unit operable to receive an input of a measurement value of biological information of the user;
an answer input unit operable to receive an input of an answer value of the user, the answer value being a self-rated achievement level with respect to a challenging target relating to a lifestyle which is concerned with the biological information; and
an answer correction unit operable to correct the answer value in accordance with a degree of difference between the answer value and an achievement level with respect to the target of the biological information, the achievement level being calculated from the measurement value of the biological information.

2. The health care assisting device according to claim 1, further comprising
a display unit operable to display the degree of difference or the post-correction answer value.

3. The health care assisting device according to claim 1, further comprising
a target value decision unit operable to decide the target value of the challenging target relating to the lifestyle through an amendment using the post-correction answer value, with reference to data that shows a correlation between the post-correction answer value and a degree of amendment to the challenging target relating to the lifestyle.

4. The health care assisting device according to claim 3, further comprising
a target value recording unit operable to record the target value of the challenging target relating to the lifestyle that is to be achieved in a predetermined period of time, the target value having been decided before a beginning of the predetermined period of time,
wherein said target value decision unit is operable to amend the target value recorded in said target value recording unit on the basis of the post-correction answer value after an end of the predetermined period of time, and to decide a target value for a next period of time subsequent to the predetermined period of time.

5. The health care assisting device according to claim 4, further comprising
a target value input unit operable to receive an input of the target value of the biological information before the beginning of the predetermined period of time,
wherein said answer correction unit is operable to calculate an achievement coefficient α that shows the achievement level with respect to the target of the biological information, on the basis of a ratio between the measurement value of the biological information and the target value of the biological information.

6. The health care assisting device according to claim 5, wherein said answer correction unit further has:
a correction coefficient calculation subunit operable to calculate a correction coefficient β, from the calculated achievement coefficient α, that shows the degree of difference between the answer value and the achievement level with respect to the target of the biological information; and
an answer value correction subunit operable to correct the answer value using the calculated correction coefficient β.

7. The health care assisting device according to claim 6, wherein said target value decision unit has:
an amendment function holding subunit operable to hold an amendment function used for amending the target value of the challenging target relating to the lifestyle, that is to be achieved in the predetermined period of time, in accordance with an achievement level achieved during the predetermined period of time with respect to the challenging target relating to the lifestyle; and
a target value amendment subunit operable to set the answer value corrected using the correction coefficient β as the achievement level with respect to the challenging target relating to the lifestyle, and to amend the target value of the predetermined period of time using the amendment function, and
said target value decision unit is operable to set the amended target value of the predetermined period of time as a target value of the challenging target relating to the lifestyle that is to be achieved in a next period of time subsequent to the predetermined period of time.

8. The health care assisting device according to claim 3, further comprising
a target value input unit operable to receive an input of the target value of the biological information before a beginning of the predetermined period of time,
wherein said target value decision unit is operable to, instead of deciding the target value of the challenging target relating to the lifestyle on the basis of the post-correction answer value, decide the target value which becomes a target of the biological information for a next period of time subsequent to the predetermine period of time.

9. The health care assisting device according to claim 3, further comprising
a target value input unit operable to, in a case where there are a plurality of challenging targets relating to the lifestyle that the user is to achieve in a predetermined period of time, receive inputs of: target values of the plurality of the challenging targets; and a target value of biological information that is most concerned with one or more of the plurality of the challenging targets,
wherein said measurement value input unit is operable to receive the input of the measurement value of the biological information, the target value of the biological information having been received,
said answer input unit is operable to receive, after an end of the period, inputs of answer values regarding achievement levels with respect to the plurality of the challenging targets relating to the lifestyle,
said answer correction unit is operable to compare the measurement value of the biological information and the target value of the biological information, to set the comparison result as the achievement level, and to correct the answer value in accordance with a degree of difference between the answer value and the achievement level, and
said target value decision unit is operable to decide target values of the plurality of the challenging targets relating to the lifestyle to be achieved in a next period of time subsequent to the predetermined period of time, using the post-correction answer values in consideration of data that shows correlations between the post-correction answer values and degrees of amendment to the plurality of the challenging targets relating to the lifestyle.

10. The health care assisting device according to claim 9,
wherein said answer correction unit is operable to calculate the achievement coefficient α that shows the achievement level of the measurement value s of the biological information inputted after the end of the predetermined period of time with respect to the target value t of the biological information inputted at the beginning of the predetermined period of time, according to a function shown in a mathematical expression 1:
α=k·(t/s), where k>0 (the mathematical expression 1),
and operable to correct the answer value using the calculated achievement coefficient α.

11. The health care assisting device according to claim 10, wherein said answer correction unit further has:
a correction coefficient calculation subunit operable to calculate the correction coefficient β according to a function shown in a mathematical expression 2:
β=1·(sx/d), where 1>0 (the mathematical expression 2),
from the achievement coefficient α and an answer value sx, out of a plurality of answer values sx (x is a positive integer 1 to n) regarding achievement levels with respect to the plurality of the challenging targets of the lifestyle, regarding the achievement level with respect to the challenging target of the lifestyle that is most concerned with the biological information for which the achievement coefficient a was calculated; and
an answer value correction subunit operable to correct each of the answer values sx on the basis of the calculated correction coefficient β.

12. The health care assisting device according to claim 11,
wherein said answer value correction subunit is operable to correct each of the answer values sx (x is a positive integer 1 to n) on the basis of the correction coefficient β, using a function shove in a mathematical expression 3:
γx=sx/β (the mathematical expression 3).

13. The health care assisting device according to claim 12,
wherein said target value decision unit is operable to amend each of the target values tx to a Tx (x is a positive integer 1 to n) according to a function Jx shown in a mathematical expression 4, from a post-correction achievement level γx (x is a positive integer 1 to n) and the target value tx (x is a positive integer 1 to n) of the challenging target of the lifestyle that was inputted at the beginning of the predetermined period of time:
Tx=Jx(tx,γx) (the mathematical expression 4),
and operable to decide each amended value Tx (x is a positive integer 1 to n) as a target value of the challenging target relating to the lifestyle to be achieved in a next period of time subsequent to the predetermined period of time.

14. A health care assisting system comprising a biological information measurement instrument which measures biological information of a human body and a health care assisting device which assists health care of a user,
wherein said biological information measurement instrument has:
a measurement unit operable to measure the biological information of the user; and
a transmission unit operable to transmit a measurement value measured by said measurement unit to said health care assisting device, and
said health care assisting device has:
a measurement value input unit operable to receive an input of the measurement value from said biological information measurement instrument;
an answer input unit operable to receive an input of an answer value which is a self-rated value of the user regarding an achievement level that shows how much a challenging target relating to a lifestyle has been achieved; and
an answer correction unit operable to correct the answer value in accordance with a degree of difference between the answer value and an achievement level with respect to the target of the biological information, the achievement level being calculated from the measurement value.

15. A health care assisting method for assisting health care of a user, said method comprising:
a measurement value input step of receiving an input of a measurement value of biological information of the user;
an answer input step of receiving an input of an answer value of the user, the answer value being a self-rated achievement level with respect to a challenging target relating to a lifestyle which is concerned with the biological information; and
an answer correction step of correcting the answer value in accordance with a degree of difference between the answer value and an achievement level with respect to the target of the biological information, the achievement level being calculated from the measurement value of the biological information.

16. The health care assisting method according to claim 15, further comprising
a display step of displaying the degree of difference or the post-correction answer value.

17. The health care assisting method according to claim 15, further comprising
a target value decision step of deciding the target value of the challenging target relating to the lifestyle through an amendment using the post-correction answer value, with reference to data that shows a correlation between the post-correction answer value and a degree of amendment to the challenging target relating to the lifestyle.

18. A program for a health care assisting device which assists health care of a user, said program causing a computer to execute: a measurement value input step of receiving an input of a measurement value of biological information of the user; an answer input step of receiving an input of an answer value of the user, the answer value being a self-rated achievement level with respect to a challenging target relating to a lifestyle which is concerned with the biological information; and an answer correction step of correcting the answer value in accordance with a degree of difference between the answer value and an achievement level with respect to the target of the biological information, the achievement level being calculated from the measurement value of the biological information.
